(19) United States
(12) Patent Application Publication
(10) Pub. No.: US 2007/0006255 A1
(43) Pub. Date: Jan. 4, 2007

(54) Digital media recorder highlight system

(76) Inventor: David Charles Cain, Richardson, TX (US)

Correspondence Address: David Cain, Suite 143, 1333 W. Campbell Rd., Richardson, TX, 75080, US

(21) Appl. No.: 11/152,331

(22) Filed: Jun. 13, 2005

(51) Int. Cl. H04N 7/10

(52) U.S. Cl. 725/36

(57) ABSTRACT

A process for displaying a user-selected presentation of video segments from video content may be performed by receiving and recording content and receiving and recording segment data. Selection instructions are received wherein the instructions are associated with segment data. Video segments associated with said selection instructions from said content with said segment data are retrieved and displayed.

### TECHNICAL FIELD OF THE INVENTION

The method and system relate to the field of media content distribution and display.

### BACKGROUND OF THE INVENTION

With the introduction of digital video recorders, media presentation has changed radically. The bandwidth that can be devoted to an entertainment or information broadcast can be determined by the level of interest rather than limits to the bandwidth. Metadata may be associated with the content signals.

What is needed, therefore, is a media content distribution system for providing media content with metadata.

### SUMMARY OF THE INVENTION

A process for displaying a user-selected presentation of video segments from video content may be performed by receiving and recording content and receiving and recording segment data. Selection instructions are received wherein the instructions are associated with segment data. Video segments associated with said selection instructions from said content with said segment data are retrieved and displayed.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a DVR distributed remote system;

FIG. 2 illustrates a mixed content generation process;

FIG. 3 illustrates a DVR advertising system;

FIG. 4 illustrates a media recorder;

FIG. 5 illustrates a video subtitling system;

FIG. 6 illustrates a cellular phone—remote control;

FIG. 7 illustrates an associated component process;

FIG. 8 illustrates a media distribution system;

FIG. 9 illustrates a user-selected highlight process;

FIG. 10 illustrates a video subtitling process;

FIG. 11 illustrates a video-on-demand DVR process;

FIG. 12 illustrates a media recorder with memory interface;

FIG. 13 illustrates a video display with subtitles;

FIG. 14 illustrates a video highlights process;

FIG. 15 illustrates a subtitle selection process;

FIG. 16 illustrates a mixed content display system;

FIG. 17 illustrates a power grid content distribution system; and

FIG. 18 illustrates video highlights diagrams.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments. The disclosed systems, components and processes contemplate substitution and combination of the disclosed systems, components and processes, even where the substitutions and combinations are not expressly disclosed.

In embodiments, communications networks may include a comparatively high-capacity backbone link, such as a fiber optic or other link, connecting to a content provider, for transmission over which a carrier or other entity impose a per-megabyte or other metered or tariffed cost. A typical home network may be compatible with a high speed wired or wireless networking standard (e.g., Ethernet, HomePNA, 802.11a, 802.11b, 802.11g, 802.11g over coax, IEEE1394, etc.) although non-standard networking technologies may also be employed such as is currently available from companies such as Magis, FireMedia, and Xtreme Spectrum. A plurality of networking technologies may be employed with a network bridge as known in the art. A wired networking technology (e.g., Ethernet) may be used to connect fixed location devices, while a wireless networking technology (e.g., 802.11g) may be used to connect mobile devices.

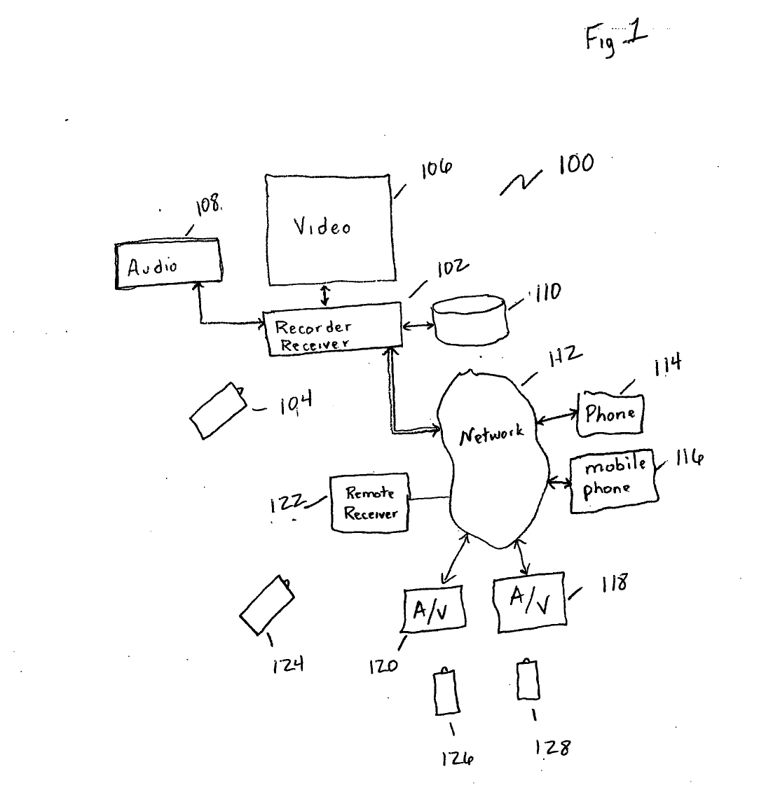

With reference to FIG. 1, a digital video recorder distributed remote system 100 is shown. A media recorder 102 may provide content to a video rendering system 106. A media recorder 102 may provide content to an audio rendering system 108. Content and other data may be stored on storage 110. The media recorder is typically connected to a network 112.

The media server may be also capable of being a receiving device for audio visual information and interfacing to a legacy device television. Networks that consolidate and distribute audiovisual information are also well known. Satellite and cable-based communication networks broadcast a significant amount of audio and audiovisual content. Further, these networks also may be constructed to provide programming on demand, e.g., video-on-demand. In these environments a signal is broadcast, multicast, or unicast via a servicing network, and a set top box local to a delivery point receives, demodulates, and decodes the signal and places the audiovisual content into an appropriate format for playing on a delivery device, e.g., monitor and audio system.

The network 112 may provide communication between a variety of systems including a telephone 114, a mobile telephone 116, other audio-visual rendering systems 118 and 120. Many of the devices, including the media recorder 102, the audio 108 and video 106 rendering systems may provide for input using a remote control 104, 124, 126 and 128.

Recording of the audiovisual information for later playback has been recently introduced as an option for set-top-boxes. In such case, the set top box may include a hard drive that stores encoded audiovisual information for later playback. As used herein and in the appended claims, the term “display” will be understood to refer broadly to any video monitor or display device capable of displaying still or motion pictures including but not limited to a television. The term “audiovisual device” will be understood to refer broadly to any device that processes video and/or audio data including, but not limited to, television sets, computers, camcorders, set-top boxes, Personal Video Recorders (PVRs), video cassette recorders, digital cameras and the like. The term “audiovisual programming” will refer to any programming that can be displayed and viewed on a television set or other display device, including motion or still pictures with or without an accompanying audio soundtrack.

A remote receiver 122 may allow a remote 124 to function apart from a rendering device. With this configuration, the control of various devices can be displayed by the media recorder at the visual renderer and the devices can be controlled by any of the remotes.

“Audiovisual programming” will also be defined to include audio programming with no accompanying video that can be played for a listener using a sound system of the television set or entertainment system. Audiovisual programming can be in any of several forms including, data recorded on a recording medium, an electronic signal being transmitted to or between system components or content being displayed on a television set or other display device. The various described components may be represented as modules comprising logic embodied in hardware or firmware. A collection of software instructions written in a programming language, such as, for example C++. A software module may be compiled and linked into an executable program, installed in a dynamic link library, or may be written in an interpretive language such as BASIC.

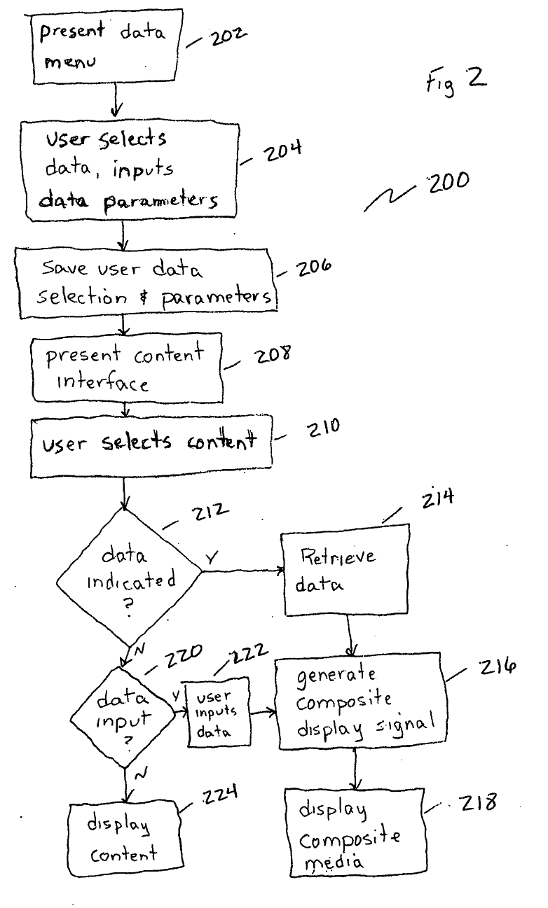

With reference to FIG. 2, a process for displaying composite media 200 is shown. A media system presents a data menu to a user at function block 202. The data menu may provide selection options to govern non-content display including thematic elements, borders, on-screen menus, photographs, wallpaper, sounds, video, dynamic content such as newsfeeds, stock prices, or any other type of data.

It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. For example, in one embodiment, the functions of the compositor device 12 may be implemented in whole or in part by a personal computer or other like device. It is also contemplated that the various described components need not be integrated into a single box. The components may be separated into several sub-components or may be separated into different devices that reside at different locations and that communicate with each other, such as through a wired or wireless network, or the Internet.

The user makes selections on the data menu and may input data parameters at function block 204. The user data selection and parameters are stored at function block 206. The media recorder presents a content menu to a user at function block 208. The user makes a selection from the content menu at function block 210.

Multiple components may be combined into a single component. It is also contemplated that the components described herein may be integrated into a fewer number of modules. One module may also be separated into multiple modules. As used herein, “high resolution” may be characterized as a video resolution that is greater than standard NTSC or PAL resolutions. Therefore, in one embodiment the disclosed systems and methods may be implemented to provide a resolution greater than standard NTSC and standard PAL resolutions, or greater than 720×576 pixels (414,720 pixels, or greater), across a standard composite video analog interface such as standard coaxial cable.

The media system determines if the content selection is compatible with a data selection at decision block 212. If data is indicated at decision block 212, the process follows the YES path to retrieve the stored data at function block 214. A composite display signal is generated using the data and content at function block 216 and displayed at function block 218. If data is not indicated at decision block 212, the process follows the NO path to decision block 220 to determine if data may be input at this time.

Examples of some common high resolution dimensions include, but are not limited to: 800×600, 852×640, 1024×768, 1280×720, 1280×960, 1280×1024, 1440×1050, 1440×1080, 1600×1200, 1920×1080, and 2048×2048. In another embodiment, the disclosed systems and methods may be implemented to provide a resolution greater than about 800×600 pixels (i.e., 480,000 pixels), alternatively to provide a resolution greater than about 1024×768 pixels, and further alternatively to provide HDTV resolutions of 1280×720 or 1920×1080 across a standard composite video analog interface such as standard coaxial cable. Examples of high definition standards of 800×600 or greater that may be so implemented in certain embodiments of the disclosed systems and methods include, but are not limited to, consumer and PC-based digital imaging standards such as SVGA, XGA, SXGA, etc.

If data is needed, the process follows the YES path to function block 222 where the user inputs data. If no data is needed, the process follows the NO path to function block 224 where the content is displayed.

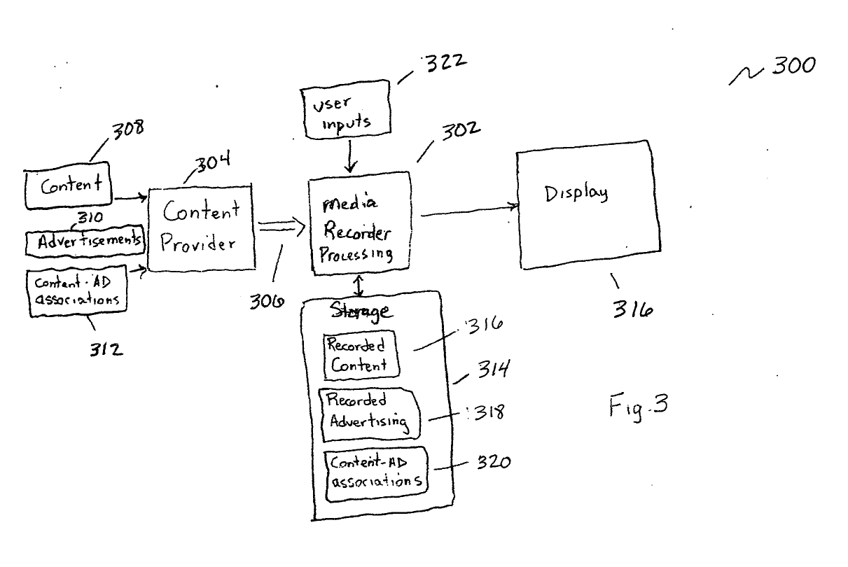

With reference to FIG. 3, a media recorder advertising system 300 is shown. Media recorder 302 receives and records content 308 provided by content provider 304 over communication network 306. Advertising content 310 and content-advertising association data 312 may be provided to media recorder 302 for recording.

It will be understood that the forgoing examples are representative of exemplary embodiments only and that the disclosed systems and methods may be implemented to provide enhanced resolution that is greater than the native or standard resolution capability of a given video system, regardless of the particular combination of image source resolution and type of interface. Media content may be delivered to homes via cable networks, satellite, terrestrial, and the Internet. The content may encrypted or otherwise scrambled prior to distribution to prevent unauthorized access. Conditional access systems reside with subscribers to decrypt the content when the content is delivered.

The content 308, advertising content 310 and content-advertising association data 312 may be provided by different content providers 304, and may be provided over different communication networks 306. Storage 314 may store recorded content 316, recorded advertising content 318 and recorded content-advertisement association data 320. In accordance with user inputs 322, the media recording processor 302 provides content 316 and advertising 318 in accordance with a content-advertisement association data 320 to the display 324.

Media systems implement conditional access policies that specify when and what content the viewers are permitted to view based on their subscription package or other conditions. In this manner, the conditional access systems ensure that only authorized subscribers are able to view the content. Conditional access systems may support remote control of the conditional access policies. This allows content providers to change access conditions for any reason, such as when the viewer modifies subscription packages. Conditional access systems may be implemented as a hardware based system, a software based system, a smartcard based system, or hybrids of these systems. In the hardware based systems, the decryption technologies and conditional policies are implemented using physical devices.

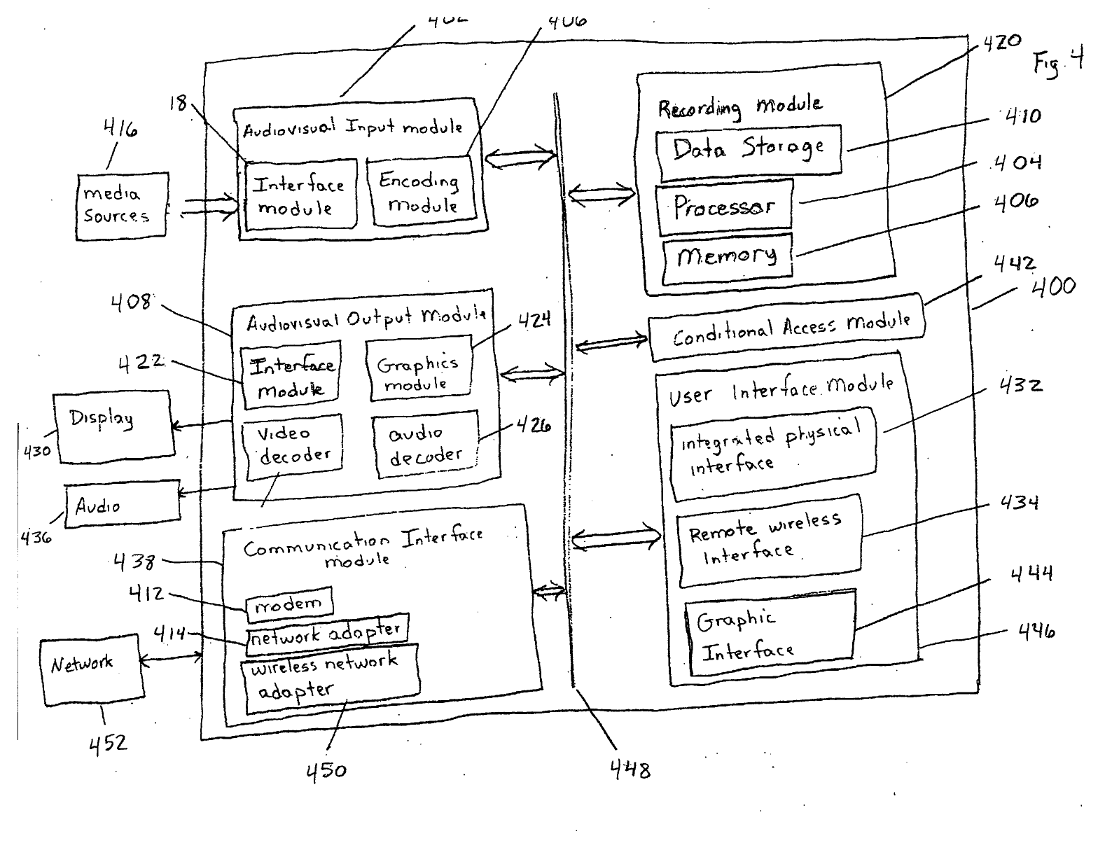

With reference to FIG. 4, a media recorder 400 in accordance with a disclosed embodiment is shown. The media recorder 400 may include an audiovisual input module 402. The audiovisual input module 402 may receive media signals from a content provider 416 or other media sources.

The hardware-centric design is considered reasonably reliable from a security standpoint, because the physical mechanisms can be structured so that they are difficult to attack. However, the hardware solution has drawbacks in that the systems may not be easily serviced or upgraded and the conditional access policies are not easily renewable. Software-based solutions, such as digital rights management designs, rely on obfuscation for protection of the decryption technologies. With software-based solutions, the policies are easy and inexpensive to renew, but such systems can be easier to compromise in comparison to hardware-based designs. Smartcard based systems rely on a secure microprocessor.

The media recorder may include an audiovisual output module 408. The audiovisual output module 408 may output media signals to a display 430, an audio rendering device 436 or other appropriate output devices. The media signals may be processed, stored or transferred by a media recording module 420 including a media recorder processor 404 and processing memory 406. Data storage medium 410 is typically used to stored the recorded media data.

Smart cards can be inexpensively replaced, but have proven easier to attack than the embedded hardware solutions. During playback operation, an instruction may be received to accelerate—“fast-forward”—the effective frame rate of the recorded content signal stream being played. The apparent increase in frame rate is generally accomplished by periodically reducing the number of content frames that are displayed. Typically, multiple acceleration rates may be enabled, providing display at multiple fast-forward speeds. An accelerated display of a video signal recorded at a standard rate, such as thirty frames per second, may display the video at effectively higher frame rates although the actual rate the frames are displayed does not change. For example, where a digital video recorder 108 includes three fast-forward settings, the fast-forward frame rates may appear to be 60 frames per second, 90 frames per second and 120 frames per second.

The media recorder 400 may communicate with other components or systems either directly or through a network 452 with a communication interface module 438. The communication interface module 438 may implement a modem 412, network interface 414, wireless interface 450 or any other suitable communication interface.

The remote control used to control a media recorder may be a personal remote, where data sent from the remote control to the digital video recorder identifies the person associated with the remote control device. Where an authentication process has been used to authenticate the personal remote, the use of the personal remote could provide a legally binding signature for interactions, including any commercial transactions. In accordance with an embodiment, the personal remote could be a cellular telephone, personal digital assistant, or any other appropriate personal digital device. An integrated personal remote with a microphone and camera, such as might be found on a cellular phone, could be used for live interaction through the media recorder system with product representatives or other interactions.

The elements of the media recorder 400 may be interconnected by a conventional bus architecture 448. Generally, the processor 404 executes instructions such as those stored in processing memory 408 to provide functionality. Processing memory 408 may include dynamic memory devices such as RAM or static memory devices such as ROM and/or EEPROM. The processing memory 408 may store instructions for boot up sequences, system functionality updates, or other information.

A personal remote could communicate wirelessly with the media system using I/R, radio communications, etc. A docking station could be used to directly connect the portable device to the system. An interface port, such as a USB port, may be built into the portable communication device for direct connection to a digital video recorder, content receiver or any networked device. Where product viewings, purchases and identity are associated and logged, demographic and habit patterns could be provided to advertisers, product suppliers and other interested parties. Using this data collection, personalized recommendations could be provided to the identified user. In accordance with the practices of persons skilled in the art of computer programming, there are descriptions referring to symbolic representations of operations that are performed by a computer system or a like electronic system. Such operations are sometimes referred to as being computer-executed.

Communication interface module 438 may include a network interface 414. The network interface 414 may be any conventional network adapter system. Typically, network interface 414 may allow connection to an Ethernet network 452. The network interface 414 may connect to a home network, to a broadband connection to a WAN such as the Internet or any of various alternative communication connections. Communication interface module 438 may include a wireless network interface 450.

It will be appreciated that operations that are symbolically represented may include the manipulation by a processor, such as a central processing unit, of electrical signals representing data bits and the maintenance of data bits at memory locations such as in system memory, as well as other processing of signals. The memory locations where data bits are maintained may be physical locations that have particular electrical, magnetic, optical, or organic properties corresponding to the data bits. Thus, the term “server” may be understood to include any electronic device that contains a processor, such as a central processing unit. When implemented in software, processes may be embodied essentially as code segments to perform the necessary tasks. The program or code segments may be stored in a processor readable medium or transmitted by a computer data signal embodied in a carrier wave over a transmission medium or communication link.

Typically, wireless network interface 450 permits the media recorder to connect to a wireless communication network. A user interface module 446 provides user interface functions. The user interface module 446 may include integrated physical interfaces 432 to provide communication with input devices such as keyboards, touch-screens, card readers or other interface mechanisms connected to the media recorder 400.

The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

The user may control the operation of the media recorder 400 through control signals provided on the exterior of the media recorder 400 housing through integrated user input interface 432. The media recorder 400 may be controlled using control signals originating from a remote control, which are received through the remote signals interface 434, in a conventional fashion. Other conventional electronic input devices may also be provided for enabling user input to media recorder 400, such as a keyboard, touch screen, mouse, joy stick, or other device.

Telecommunication systems distribute content objects. Various systems and methods utilize a number of content object entities that can be sources and/or destinations for content objects. A combination of abstraction and distinction engines can be used to access content objects from a source of content objects, format and/or modify the content objects, and redistribute the modified content object to one or more content object destinations. In some cases, an access point is included that identifies a number of available content objects, and identifies one or more content object destinations to which the respective content objects can be directed.

These devices may be built into media recorder 400 or associated hardware (e.g., a video display, audio system, etc.), be connected through conventional ports (e.g., serial connection, USB, etc.), or interface with a wireless signal receiver (e.g., infrared, Bluetooth™, 802.11b, etc.). A graphical interface module 444 provides graphical interfaces on a display to permit user selections to be entered.

Such systems and methods can be used to select a desired content object, and to select a content object entity to which the content object is directed. In addition, the systems and methods can be used to modify the content object as to format and/or content. For example, the content object may be reformatted for use on a selected content object entity, modified to add additional or to reduce the content included in the content object, or combined with one or more other content objects to create a composite content object. This composite content object can then be directed to a content object destination where it can be either stored or utilized. Abstraction and distinction processes may be performed on content objects. These systems may include an abstraction engine and a distinction engine.

The audiovisual input module 402 receives input through an interface module 418 that may include various conventional interfaces, including coaxial RF/Ant, S-Video, component audio/video, network interfaces, and others. The received signals can originate from standard NTSC broadcast, high definition television broadcast, standard cable, digital cable, satellite, Internet, or other sources, with the audiovisual input module 402 being configured to include appropriate conventional tuning and decoding functionality.

The abstraction engine may be communicably coupled to a first group of content object entities, and the distinction engine may communicably coupled to second group of content object entities. The two groups of content object entities are not necessarily mutually exclusive, and in many cases, a content object entity in one of the groups is also included in the other group. The first of the groups of content object entities may include content objects entities such as an appliance control system, a telephone information system, a storage medium including video objects, a storage medium including audio objects, an audio stream source, a video stream source, a human interface, the Internet, and an interactive content entity.

The media recorder 400 may also receive input from other devices, such as a set top box or a media player (e.g., VCR, DVD player, etc.). For example, a set top box might receive one signal format and outputs an NTSC signal or some other conventional format to the media recorder 400. The functionality of a set top box, media player, or other device may be built into the same unit as the media recorder 400 and share one or more resources with it. The audiovisual input module 402 may include an encoding module 436.

The second group of content object entities may include content object entities such as an appliance control system, a telephone information system, a storage medium including video objects, a storage medium including audio objects, a human interface, the Internet, and an interactive content entity. In some instances, two or more of the content object entities are maintained on separate partitions of a common database. In such instances, the common database can be partitioned using a content based schema, while in other cases the common database can be partitioned using a user based schema.

The encoding modules 436 convert signals from a first format (e.g., analog NTSC format) into a second format (e.g., MPEG 2, etc.) so that the signal converted into the second format may be stored in the memory 408 or the data storage medium 410 such as a hard disk. Typically, content corresponding to the formatted data stored in the data storage medium 410 may be viewed immediately, or at a later time.

In particular instances, the abstraction engine may be operable to receive a content object from one of the groups of content object entities, and to form the content object into an abstract format. As just one example, this abstract format can be a format that is compatible at a high level with other content formats. In other instances, the abstraction engine is operable to receive a content object from one of the content object entities, and to derive another content object based on the aforementioned content object.

Additional information may be stored in association with the media data to manage and identify the stored programs. Other embodiments may use other appropriate types of compression. The audiovisual output module 408 may include an interface module 422, a graphics module 424, video decoder 428 and audio decoder 426. The video decoder 428 and audio decoder 426 may be MPEG decoders.

Further, the abstraction engine can be operable to receive yet another content object from one of the content object entities and to derive an additional content object there from. The abstraction engine can then combine the two derived content objects to create a composite content object. In some cases, the distinction engine accepts the composite content object and formats it such that it is compatible with a particular group of content object entities. In yet other instances, the abstraction engine is operable to receive a content object from one group of content object entities, and to form that content object into an abstract format.

The video decoder 428 may obtain encoded data stored in the data storage medium 410 and convert the encoded data into a format compatible with the display device 430. Typically the NTSC format may be used as such signals are displayed by a conventional television set. The graphics module 424 may receive guide and control information and provides signals for corresponding displays, outputting them in a compatible format.

The distinguishing engine can then conform the abstracted content object with a standard compatible with a selected one of another group of content object entities. In some other instances, the systems include an access point that indicates a number of content objects associated with one group of content object entities, and a number of content objects associated with another group of content object entities. The access point indicates from which group of content object entities a content object can be accessed, and a group of content object entities to which the content object can be directed.

Methods for utilizing content objects may include accessing a content object from a content object entity; abstracting the content object to create an abstracted content object; distinguishing the abstracted content object to create a distinguished content object, and providing the distinguished content object to a content object entity capable of utilizing the distinguished content object. In some cases, the methods further include accessing yet another content object from another content object entity, and abstracting that content object entity to create another abstracted content object entity.

The audio decoder 426 may obtain encoded data stored in the data storage medium 410 and converts the encoded data into a format compatible with an audio rendering device 436. The media recorder 400 may process guide information that describes and allows navigation among content from a content provider at present or future times.

The two abstracted content object entities can be combined to create a composite content object entity. In one particular case, the first abstracted content object may be a video content object and the second abstracted content object may be an audio content object. Thus, the composite content object includes audio from one source, and video from another source. Further, in such a case, abstracting the video content object can include removing the original audio track from the video content object prior to combining the two abstracted content objects.

The guide information may describe and allow navigation for content that has already been captured by the media recorder 400. Guides that display this type of information may generally be referred to as content guides. A content guide may include channel guides and playback guides. A channel guide may display available content from which individual pieces of content may be selected for current or future recording and viewing. In a specific case, the channel guide may list numerous broadcast television programs, and the user may select one or more of the programs for recording. The playback guide displays content that is stored or immediately storable by the media recorder 400.

Other terminology may be used for the guides. For example, they may be referred to as programming guides or the like. The term content guide is intended to cover all of these alternatives. The media recorder 400 may also be referred to as a digital video recorder or a personal video recorder. Although certain modular components of a media recorder 400 are shown in FIG. 4, the present invention also contemplates and encompasses units having different features. For example, some devices may omit a telephone line modem, instead using alternative conduits to acquire guide data or other information used in practicing the present invention.

As yet another example, the first abstracted content object can be an Internet object, while the other abstracted content object is a video content object. In other cases, the methods can further include identifying a content object associated with one group of content object entities that has expired, and removing the identified content object. Other cases include querying a number of content object entities to identify one or more content objects accessible via the content object entities, and providing an access point that indicates the identified content objects and one or more content object entities to which the identified content objects can be directed. Methods may include accessing content objects within a customer premises.

Additionally, some devices may add features such as a conditional access module 442, such as one implementing smart card technology, which works in conjunction with certain content providers or broadcasters to restrict access to content. Additionally, although this embodiment and other embodiments of the present invention are described in connection with an independent media recorder device, the descriptions may be equally applicable to integrated devices including but not limited to cable or satellite set top boxes, televisions or any other appropriate device capable of including modules to enable similar functionality.

Such methods may include identifying content object entities within the customer premises, and grouping the identified content objects into two or more groups of content object entities. At least one of the groups of content object entities may include sources of content objects, and at least another of the groups of content object entities may include destinations of content objects. The methods may include providing an access point that indicates the at least one group of content object entities that can act as content object sources, and at least another group of content object entities that can act as content object destinations.

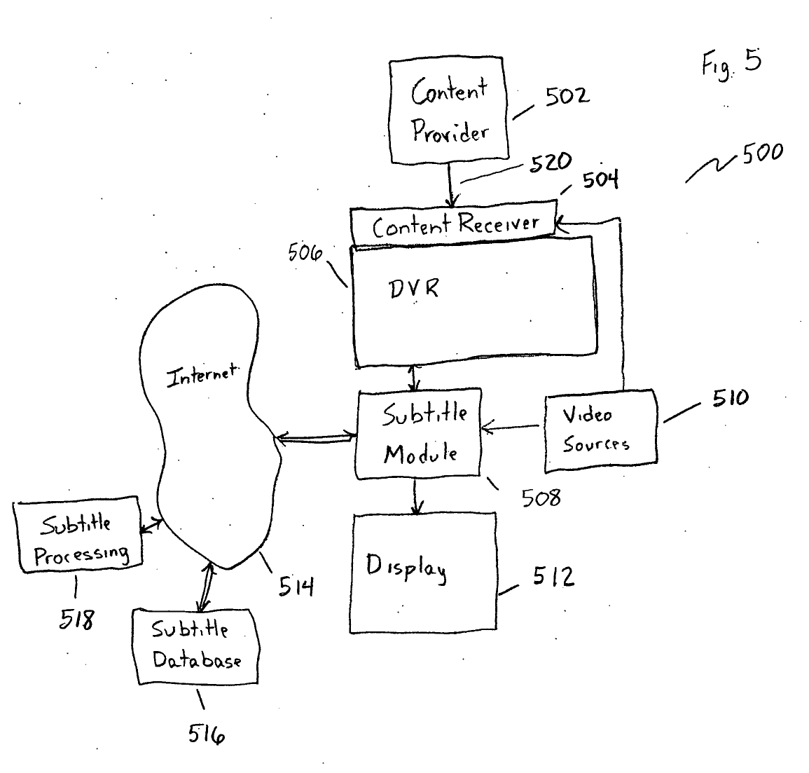

With reference to FIG. 5, a video subtitling system 500 is shown. A video subtitling system 500 may include a content provider 502. The content provider 502 provides content to a subscriber over communications network 520. A content receiver 504 receives content signal streams.

The content signal streams may be provided to a digital video recorder 506. When a content signal stream is provided for display at display 512, a subtitle module 508 receives and recognizes the content signal stream. Subtitle data may be retrieved from the content signal stream, the digital video recorder, other video sources 510 or from a subtitle database 516 over network 514.

The subtitle data may be processed by subtitle module 508 or a networked subtitle processor 518 to optimize the display of the subtitle data in accordance with subscriber preferences and/or content signal stream conditions.

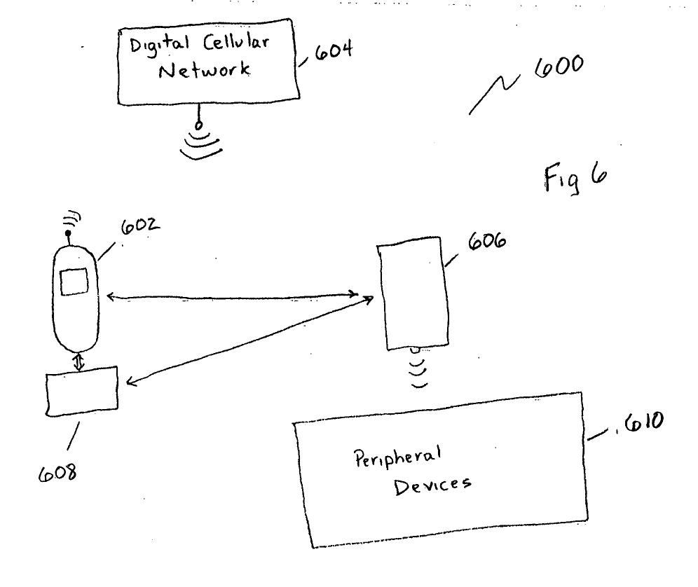

With reference to FIG. 6, a media recorder system 600 is shown. A mobile phone 602 is capable of transmitting and receiving multiple types of signals over a cellular network 604. Typically, cellular network 604 is a wireless telephony network that can be based on Code Division Multiple Access (CDMA), Time Division Multiple Access (TDMA), Global System for Mobile Communications (GSM), or other telephony protocols.

A header embedded within incoming signals received by mobile phone 602 from cellular network 604 indicates the type of signal received. The most common type of signal is a voice signal for purposes of a carrying on a full-duplex conversation. Data signals, however, are becoming more common to cellular networks as mobile phones become more robust with respect to sending and receiving textual, audio, and image or video data.

A received voice signal is typically decoded by mobile phone 602 into an analog audio signal while a data signal is processed internally by appropriate hardware and software within mobile phone 602. A multimedia signal is handled by mobile phone 602 as containing separate voice and data components. Signals containing voice, data, or multimedia content are processed according to known wireless standards such as Short Messaging Service (SMS), Multimedia Messaging Service (MMS), or Adaptive Multi-Rate (AMR) for voice.

Mobile phone 602 is also capable of creating and transmitting a multimedia message over cellular network 604 using an integrated microphone and camera if so equipped. Multimedia messages can be created by the mobile phone 602 via direct user manipulation or remotely from a remote 606. Mobile phone 602 is further capable of re-transmitting or relaying a received signal from cellular network 604 to remote 606 and vice-versa. Communication to and from remote 606 is over a wireless protocol using a licensed or unlicensed frequency band having enough bandwidth to accommodate digital voice, data, or multimedia signals.

For example, it can be based on the Bluetooth, the 802.11(a, b, g, h, or x) protocols, or other known protocol using the 2.4 GHz, 5.8 GHz, 900 MHz, or 800 MHz spectrum. To facilitate interaction with remote 606, mobile phone 602 may use a separate lower power RF unit from the primary RF unit used for interaction with cellular network 604. If mobile phone 602 is not equipped with the capability to interact with remote 606, then a base unit 608 can be used to interact with remote 606.

Mobile phone 602 can be positioned in base unit 608 in such a way as to allow a signal received by mobile phone 602 to be communicated over a serial communications port to base unit 608. Base unit 608 may be equipped with a serial communications port to receive signals from mobile phone 602. Base unit 608 is also equipped with an RF unit so as to be able to interact with remote 606. Base unit 608 can act as an intermediary between mobile phone 602 and remote 606.

Base unit 608 can transmit and receive signals between mobile phone 602 and remote 606. Base unit 608 may typically have access to an independent power source. Access to a power source allows base unit 608 to transmit and receive signals over longer distances than the mobile phone 602 is capable of transmitting and receiving signals with its reduced power secondary RF unit.

Base unit 608 may be used even if mobile phone 602 is equipped to interact with remote 606 in order to accommodate communication over a longer distance. The power source also allows base unit 608 to perform its primary duty of re-charging the battery in mobile phone 602. Remote 606 may be equipped with an RF unit for interacting with mobile phone 602 and/or base unit 608.

Remote 606 may transmit and receive signals to and from mobile phone 602 and may transmit signals to other peripheral devices 610. Typically, peripheral devices may include home entertainment system components such as a television, a stereo including associated speakers, or a personal computer (PC). Remote 606 may include a digital signal processor (DSP)/microprocessor having multimedia codec capabilities. Remote 606 may be equipped with a microphone and speaker to enable a user to conduct a conversation through mobile phone 602 in a full-duplex manner.

By including a microphone and speaker, remote 606 may be used as an extension telephone to carry out a conversation that was initiated by mobile phone 602. Remote 606 may access and control aspects of mobile phone 602. Remote control 606 may access mobile phone 602 to enable voice dialing or to create an SMS or MMS message.

Remote 606 may have the ability to relay, re-route, or re-transmit signals to other peripheral devices 610 that are under the control of remote 606. These other electronic devices may also be controlled by remote 606 using, for example, an infrared or RF link. Remote 606 may route re-transmit a signal from mobile phone 602 or base unit 608 directly to other peripheral devices 610.

A picture caller ID signal, received by mobile phone 602 from cellular network 604, for instance, can be automatically forwarded by either mobile phone 602 or base unit 608 to remote 606 and then on to a television for display. Remote 606 also contains an internal, rechargeable power supply to facilitate untethered operation. If the peripheral device 610 is a television, for instance, the television can receive re-transmitted or relayed signals from remote 606.

For the convenience of the user, an incoming call can trigger a chain of events that ensures the user does not miss anything being watched on the television. Many televisions are now equipped, either internally or via a controllable accessory, with a digital video recorder that has the ability to pause live television and save video data to a hard drive.

Thus, if a call is received on mobile phone 602 and mobile phone 602 is out of reach of the user, then the call information and the call itself can be forwarded to remote 606. If the user decides to answer the call using remote 606, then remote 606 could cause the television to pause until the call is complete or the user overrides the pause function.

A television includes integrated speakers capable of broadcasting audio. Further, many televisions are capable of displaying both digital and analog video as well as displaying and/or broadcasting multimedia in commonly know wireless executable formats including, but not limited to, MMS, SMS, Caller ID, Picture Caller ID, and Joint Photographic Experts Group (JPEG).

Audio may be broadcasted in a variety of formats including, but not limited to, Musical Instrument Digital Interface (MIDI) or MPEG Audio Layer 3 (MP3). Voice, data, audio, or MMS message executions can be displayed in a “picture in picture” window on a television. Thus, data originally intended for and received by mobile phone 602 can be routed or re-transmitted to a television via remote 606 to enhance the look and sound of the data on a larger screen display.

A television may also be compatible with other peripheral devices in a home entertainment system including, but not limited to, high-power speakers, a digital video recorder (DVR), digital video disc (DVD) players, videocassette recorders (VCRs), and gaming systems. A television may also contain multimedia codec abilities.

The codec provides the television with the capability to synchronize audio and video for displaying multimedia messages without frame lagging, echo, or delay while simultaneously carrying on a full-duplex conversation with its speaker output and audio input received from remote 606 via mobile phone 602 or base unit 608. High-power speakers can receive audio from a wired connection from a television or from a tuner, amplifier, or other similar audio device common in a home entertainment system.

Alternatively, the speakers can be fitted with an RF unit to be compatible with remote 606. If the speakers are wireless-capable, they can output audio from mobile phone 602, base unit 608, remote 606, or a television. Audio generated at mobile phone 602 or base unit 608 can be routed directly to he speakers through a decision enacted at remote 606. Similarly, a DVR can be wired directly to a television or alternatively can contain an RF unit compatible with remote 606.

A DVR is capable of automatically recording signals displayed by a television when an incoming signal from cellular network 604 is received by mobile phone 602. This capability allows the incoming communication to/from cellular network 604 to override the normal video and audio capabilities of the television. The audio and video capabilities of the television can then be employed for communication interaction with cellular network 604 while the DVR ensures that any audio or video displaced by this feature is not lost but is instead captured for later display.

Peripheral devices 610 can include, but are not limited to, personal video recorders, DVD players, VCRs, and gaming systems. Peripheral devices 610 can be fitted with an RF unit compatible with remote 606. This compatibility allows peripheral devices 610 to recognize when mobile phone 602 receives an incoming signal from cellular network 604.

When an incoming signal is recognized by a peripheral device 610 such as a television, it can automatically pause operation so that the television can be used to interact with the incoming communication. Pausing operations may include, but are not limited to, pausing a recording operation, pausing a game, or pausing a movie display depending on the peripheral device in question.

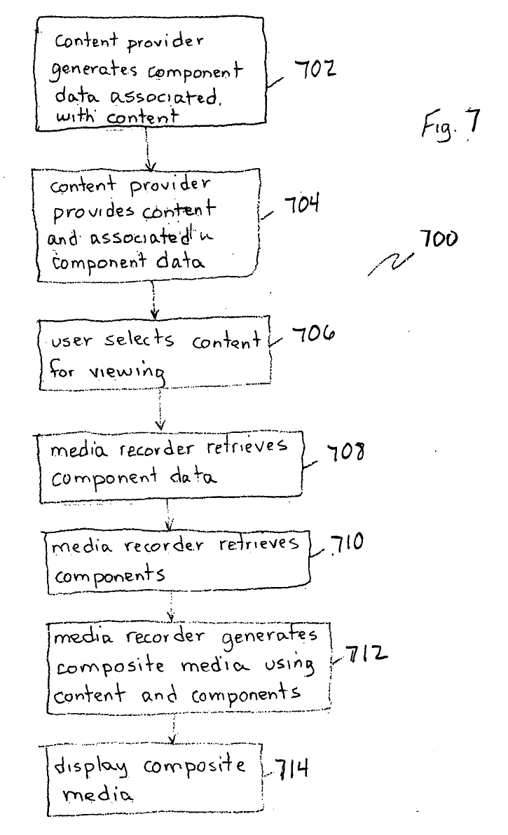

With reference to FIG. 7, a process for generating composite media 700 is shown. A content provider generates component data associated with a particular content at function block 702. For example, a sporting event content may be associated with sports-related thematic components. The component data may include the components or indicate an address where the component can be retrieved.

The content provider broadcasts or otherwise distributes the content and the associated component data at function block 704. The user selects the content for viewing on a media recorder at function block 706. The media recorder retrieves the component data associated with the content at function block 708.

If necessary, the media recorder retrieves components that are not locally available at function block 710. The media recorder generates composite media using the content and associated components at function block 712. The composite media is displayed at function block 714.

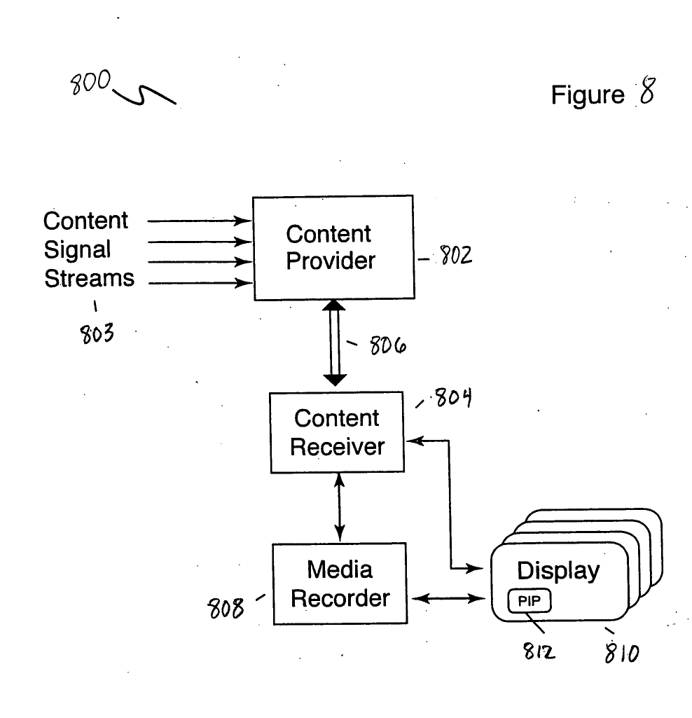

With reference to FIG. 8, a media distribution system 800 including media recording is shown. A content provider 802 provides media content signal streams 803 to a consumer content receiver 804 over a content communications network 806. Media content may be provided by providers such as cable television sources, satellite television sources, digital network sources, recorded audio and/or graphic media or any other suitable source of programming content.

Content provider 802 typically simultaneously transmits a plurality of content signal streams 803 over a communication system 806 to a content receiver 804 such as a set-top box or satellite receiver. For example, a cable television provider 802 may simultaneously transmit data representing hundreds of television programs 803 over a coaxial cable 806 to a cable subscriber's cable box 804.

The content receiver 804 may provide one or more of the content signal streams to rendering devices 810 such as televisions, stereos, portable entertainment devices or any other suitable rendering device. A typical viewer may display and watch a single program at a time. Multiple viewers in a single location may view programs displayed on multiple rendering devices. A picture-in-picture 812 may be used for simultaneous viewing of more than one received content signal stream.

The content receiver 804 may provide one or more of the content signal streams to a media recorder 808 such as a digital video recorder or other retrievable memory system such as analog video recorder, a memory device or other appropriate recording device. Typically a media system may be equipped to providing recording of one content signal while displaying a second content signal.

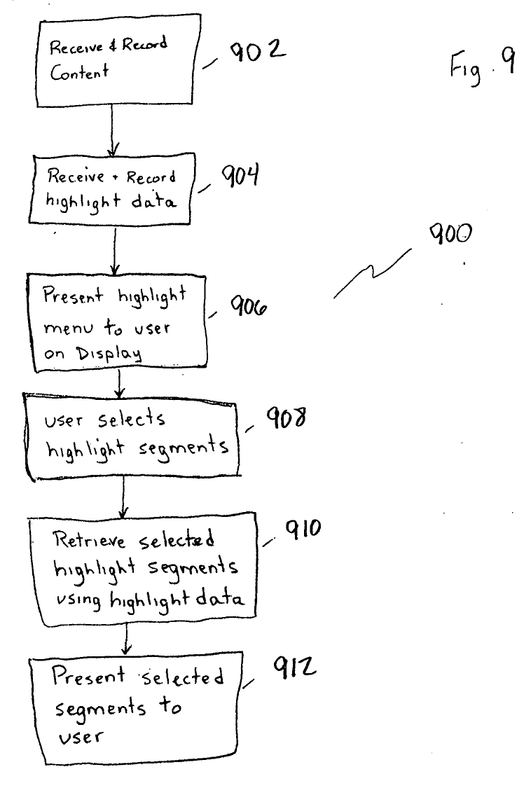

With reference to FIG. 9, a process for generating a user-selected highlight presentation 900 is shown. A media recording system receives and records content at function block 902. The media recording system further receives and records highlight data associated with the recorded content at function block 904.

A highlight menu is presented to a user on a display at function block 906. The user selects highlight segments for viewing at function block 908. The media recorder retrieves the selected highlight segments from the content using the highlight data at function block 910. The selected highlight segments are displayed at function block 912.

The World Wide Web (WWW) network uses a hypertext transfer protocol (HTTP) and is implemented within the Internet network and supported by hypertext mark-up language (HTML) servers. Communications networks may be, include or interface to any one or more of, for instance, a cable network, a satellite television network, a broadcast television network, a telephone network, an open network such as the Internet, an intranet, a local area network (LAN), a wide area network (WAN), a metropolitan area network (MAN), a storage area network (SAN), a frame relay connection, an Advanced Intelligent Network (AIN) connection, a synchronous optical network (SONET) connection, a digital T1, T3, E1 or E3 line, Digital Data Service (DDS) connection, an ATM (Asynchronous Transfer Mode) connection, an FDDI (Fiber Distributed Data Interface), CDDI (Copper Distributed Data Interface) or other wired, wireless or optical connection.

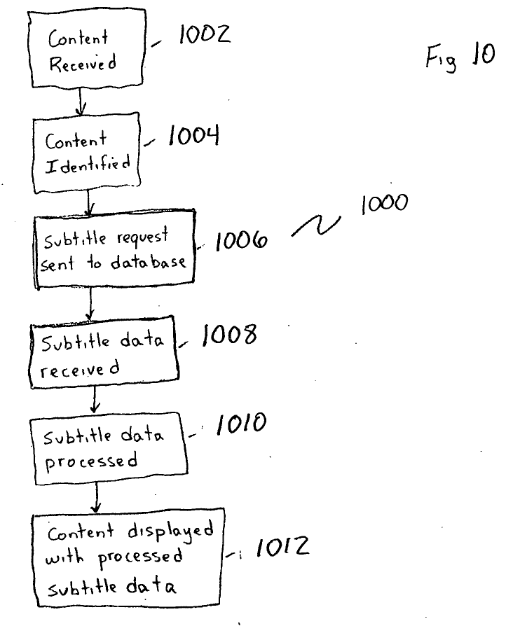

With reference to FIG. 10, a video-on-demand process 1000 in a digital video recorder system is shown. A user selects video-on-demand content for immediate display at function block 1002. A content segment priority schedule may be established at function block 1004 to assure that all content segments will be received by the user for continuous viewing.

The various communication networks employed may be implemented with different types of networks or portions of a network. The different network types may include: the conventional POTS telephone network, the Internet network, World Wide Web (WWW) network or any other suitable communication network. The POTS telephone network is a switched-circuit network that connects a client to a point of presence (POP) node or directly to a private server. The POP node and the private server connect the client to the Internet network, which is a packet-switched network using a transmission control protocol/Internet protocol (TCP/IP).

An initial segment is retrieved at function block 1006 and provided to the media recorder at function block 1008. While the initial segment is being played at function block 1010, the media recorder receives and records additional segments at function block 1012. The sequence of segments is displayed at function block 1014, as any remaining segments are received and recorded.

Conventional networking technologies may be used to facilitate the communications among the various systems. For example, the network communications may implement the Transmission Control Protocol/Internet Protocol (TCP/IP), and additional conventional higher-level protocols, such as the Hyper Text Transfer Protocol (HTTP) or File Transfer Protocol (FTP). Connection of media recorders to communication networks may allow the connected media recorders to share recorded content, utilize centralized or decentralized data storage and processing, respond to control signals from remote locations, periodically update local resources, provide access to network content providers, or enable other functions.

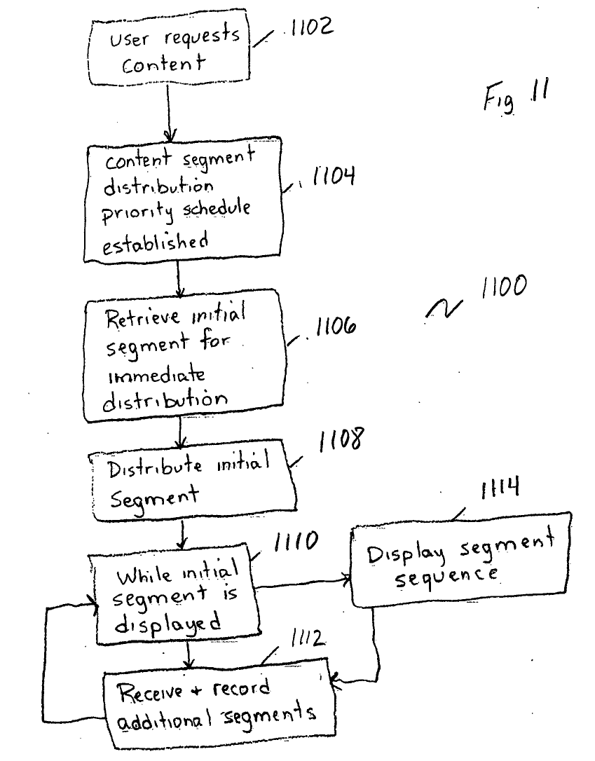

With reference to FIG. 11, a video-on-demand process 1100 in a digital video recorder system is shown. A user selects video-on-demand content for immediate display at function block 1102. A content segment priority schedule may be established at function block 1104 to assure that all content segments will be received by the user for continuous viewing.

As used herein, “programs” include news shows, sitcoms, comedies, movies, commercials, talk shows, sporting events, on-demand videos, and any other form of television-based entertainment and information. Further, “recorded programs” include any of the aforementioned “programs” that have been recorded and that are maintained with a memory component as recorded programs, or that are maintained with a remote program data store. The “recorded programs” can also include any of the aforementioned “programs” that have been recorded and that are maintained at a broadcast center and/or at a head-end that distributes the recorded programs to subscriber sites and client devices.

An initial segment is retrieved at function block 1106 and provided to the media recorder at function block 1108. While the initial segment is being played at function block 1110, the media recorder receives and records additional segments at function block 1112. The sequence of segments is displayed at function block 1114, as any remaining segments are received and recorded.

Packet-continuity counters may be implemented to ensure that every packet that is needed to decode a stream is received. Content signals may be or include any one or more video signal formats, for instance NTSB, PAL, Windows™ AVI, Real Video, MPEG-2 or MPEG-4 or other formats, digital audio for instance in .WAV, MP3 or other formats, digital graphics for instance in .JPG, .BMP or other formats, computer software such as executable program files, patches, updates, transmittable applets such as ones in Java™ or other code, or other data, media or content.

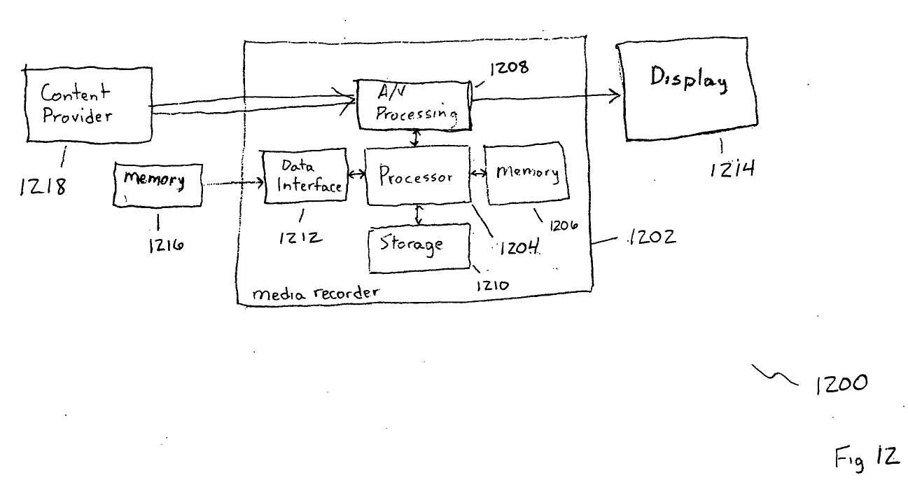

With reference to FIG. 12, a media recorder system 1200 is shown. Media recorder 1202 receives and records content from a content provider 1218. The content may be visually rendered on display 1214. Media recorder may include a processor 1204 with processing memory 1206. Content signals are coded, decoded, compressed, decompressed or otherwise processed by audio-visual processing 1208. Content signals and other data may be stored in storage 1210. A data interface 1212 may permit direct connection to data sources 1216 such as memory media, devices or other data sources such as flash memory, optical disks or other suitable devices.

The MPEG-2 metadata may include a program associated table (PAT) that lists every program in the transport stream. Each entry in the PAT points to an individual program map table (PMT) that lists the elementary streams making up each program. Some programs are open, but some programs may be subject to conditional access (encryption) and this information is also carried in the MPEG-2 transport stream, possibly as metadata. The aforementioned fixed-size data packets in a transport stream each carry a packet identifier (PID) code. Packets in the same elementary streams all have the same PID, so that a decoder can select the elementary stream(s) it needs and reject the remainder.

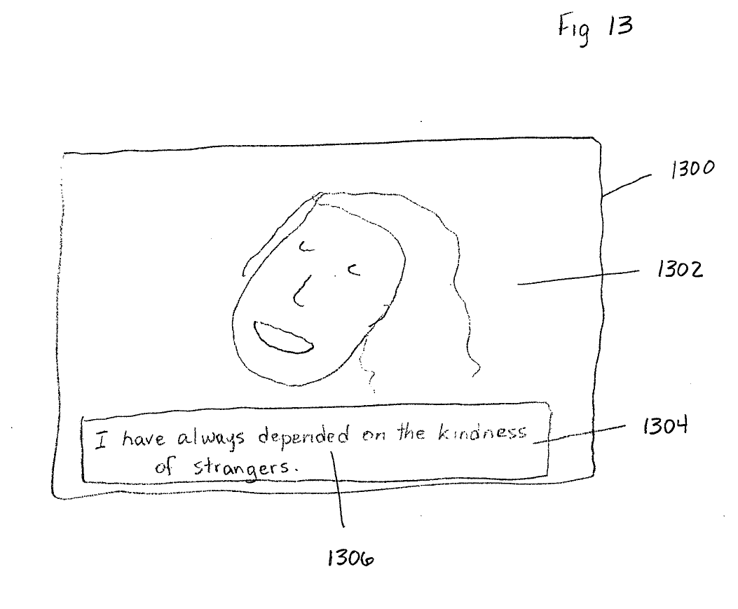

With reference to FIG. 13, a graphic display 1300 is shown. A display screen 1300 typically shown on a television, monitor or other graphic display device includes graphic images 1302. The graphic images 1302 are typically dynamic video images but may be static images. Subtitles 1304 including textual data 1306 may be displayed in conjunction with the graphic images 1302.

For digital broadcasting, multiple programs and their associated PESs are multiplexed into a single transport stream. A transport stream has PES packets further subdivided into short fixed-size data packets, in which multiple programs encoded with different clocks can be carried. A transport stream not only comprises a multiplex of audio and video PESs, but also other data such as MPEG-2 program specific information (sometimes referred to as metadata) describing the transport stream.

The textual data 1306 is typically coordinated with the graphic images 1302 so that the proper textual data 1306 is presented with the appropriate graphic image 1302. The textual data 1306 may be provided in numerous languages or forms. The placement of the textual data 1306 on the display 1300 may be determined to provide ease of reading and minimized graphic obstruction.

The B-frame contains the average of matching macroblocks or motion vectors. Because a B-frame is encoded based upon both preceding and subsequent frame data, it effectively stores motion information. Thus, MPEG-2 achieves its compression by assuming that only small portions of an image change over time, making the representation of these additional frames extremely compact. Although GOPs have no relationship between themselves, the frames within a GOP have a specific relationship which builds off the initial I-frame. The compressed video and audio data are carried by continuous elementary streams, respectively, which are broken into access units or packets, resulting in packetized elementary streams (PESs). These packets are identified by headers that contain time stamps for synchronizing, and are used to form MPEG-2 transport streams.

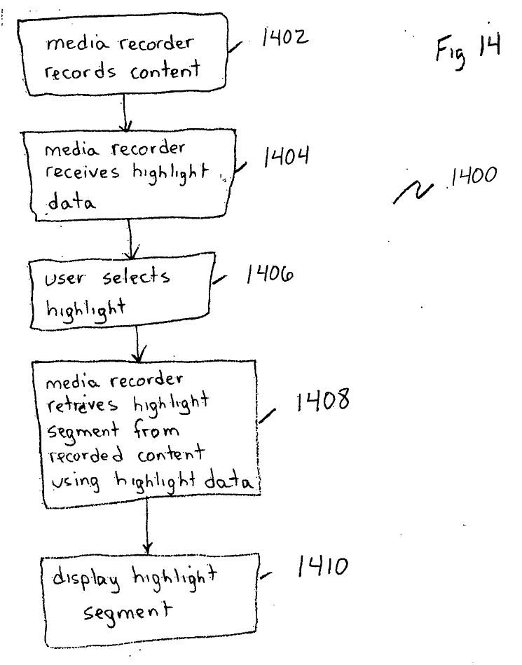

With reference to FIG. 14, a process for presenting video highlights 1400 is shown. A media recorder records content in function block 1402. The media recorder receives and records highlight data at function block 1404. The highlight data may be provided by a content provider or any other data source.

The GOP may represent additional frames by providing a much smaller block of digital data that indicates how small portions of the I-frame, referred to as macroblocks, move over time. An I-frame is typically followed by multiple P- and B-frames in a GOP. Thus, for example, a P-frame occurs more frequently than an I-frame by a ratio of about 3 to 1. A P-frame is forward predictive and is encoded from the I- or P-frame that precedes it. A P-frame contains the difference between a current frame and the previous I- or P-frame. A B-frame compares both the preceding and subsequent I- or P-frame data.

The highlight data typically indicates the frame numbers included in the highlight, or any other data to indicate a selection of video data. When the user selects a highlight for display at function block 1406, the media recorder retrieves the highlight segment video data from the recorded content using the highlight data at function block 1408. The highlight segment is displayed at function block 1410.

As a result, overrunning and underrunning of a decoder buffer can occur, which undesirably results in the freezing of a sequence of pictures and the loss of data. In accordance with the MPEG-2 standard, video data may be compressed based on a sequence of groups of pictures (GOPs), made up of three types of picture frames—intra-coded picture frames (“I-frames”), forward predictive frames (“P-frames”) and bilinear frames (“B-frames”). Each GOP may, for example, begin with an I-frame which is obtained by spatially compressing a complete picture using discrete cosine transform (DCT). As a result, if an error or a channel switch occurs, it is possible to resume correct decoding at the next I-frame.

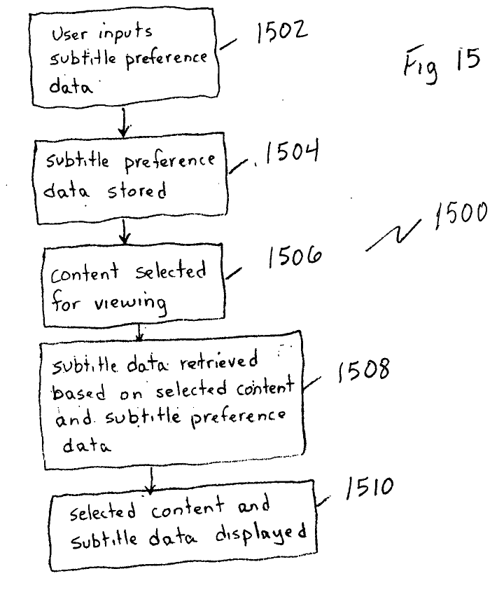

With reference to FIG. 15, a subtitle preference process 1500 is shown. A user inputs subtitle preference data at function block 1502. The subtitle preference data may indicate the user's preferences regarding language, content filtering, placement, coloring or other subtitle preferences. The subtitle preference data is stored at function block 1504.

Further, the time constraints applied to an encoding process when video is encoded in real time can limit the complexity with which encoding is performed, thereby limiting the picture quality that can be attained. One conventional method for rate control and quantization control for an encoding process is described in Chapter 10 of Test Model 5 (TM5) from the MPEG Software Simulation Group (MSSG). TM5 suffers from a number of shortcomings. An example of such a shortcoming is that TM5 does not guarantee compliance with the Video Buffer Verifier (VBV) requirement.

When content is selected for viewing at function block 1506, subtitle data corresponding to the selected content and in accordance with the user preferences is retrieved at function block 1508. The selected content and subtitle data are displayed at function block 1510.

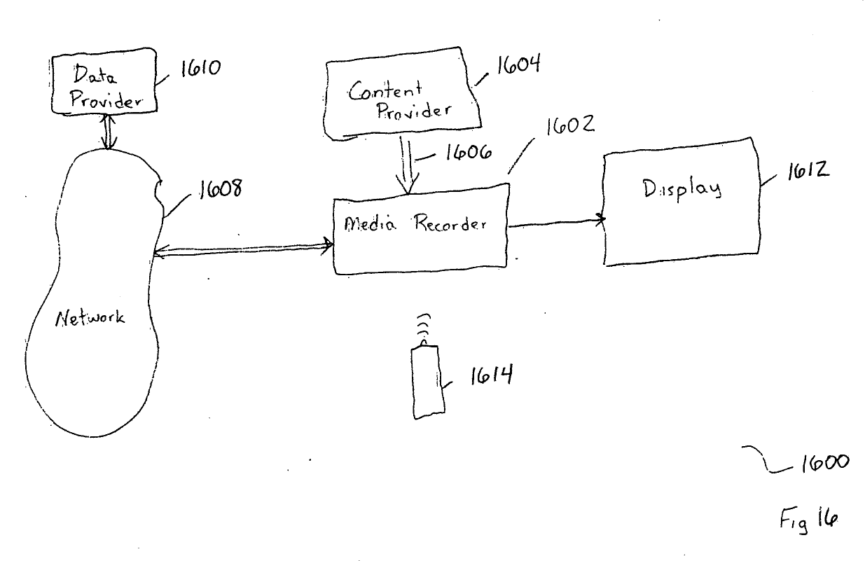

With reference to FIG. 16, a composite content display system 1600 is shown. A media recorder 1602 receives and records content from a content provider 1604 over communication network 1606. The media recorder 1602 may also receive data from a data provider 1610 over network 1608. The content and data may be provided by the media recorder 1602 for simultaneous display on video rendering device 1612. Selection of the content, data and the format for simultaneous display may be determined based on input commands from user input device 1614.

For relatively high image quality, video encoding can consume a relatively large amount of data. However, the communication networks that carry the video data can limit the data rate that is available for encoding. For example, a data channel in a direct broadcast satellite (DBS) system or a data channel in a digital cable television network typically carries data at a relatively constant bit rate (CBR) for a programming channel. In addition, a storage medium, such as the storage capacity of a disk, can also place a constraint on the number of bits available to encode images. As a result, a video encoding process often trades off image quality against the number of bits used to compress the images. Moreover, video encoding can be relatively complex. For example, where implemented in software, the video encoding process can consume relatively many CPU cycles.

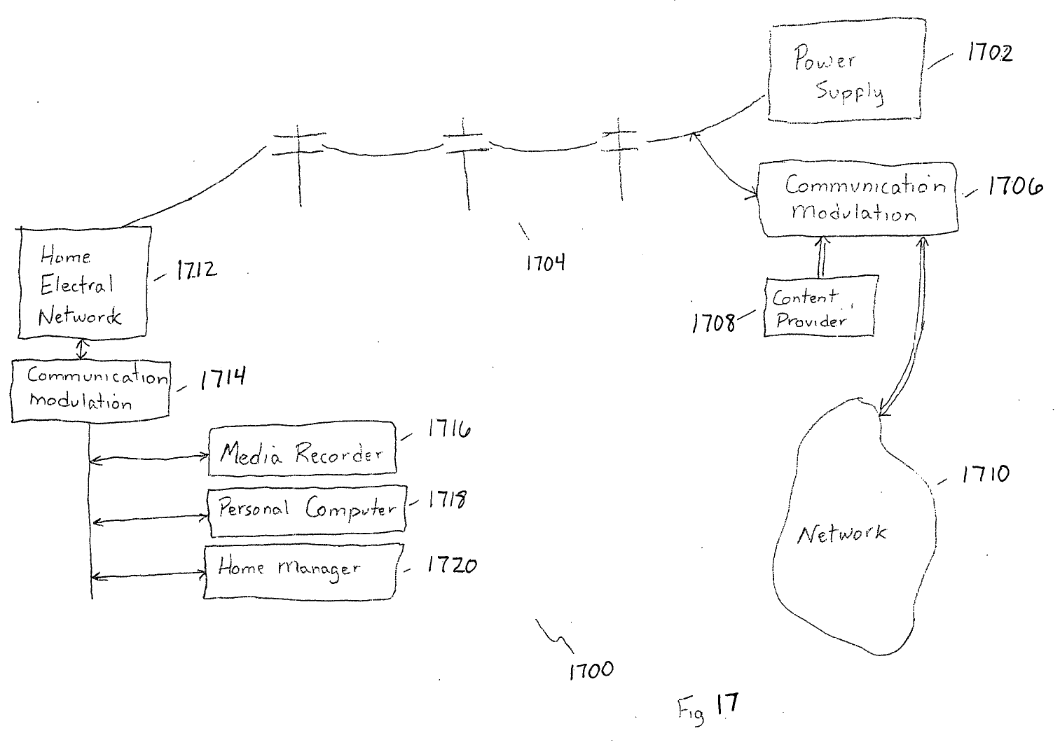

With reference to FIG. 17, a power-grid content distribution system 1700 is shown. A power supply 1702 provides energy across power-grid 1704 for use by electrical systems 1712. Communication signals may be modulated by a communication modem 1706. Content providers 1708 such as television broadcasters may provide content for modulation.

Such video compression techniques permit video data streams to be efficiently carried across a variety of digital networks, such as wireless cellular telephony networks, computer networks, cable networks, via satellite, and the like, and to be efficiently stored on storage mediums such as hard disks, optical disks, Video Compact Discs (VCDs), digital video discs (DVDs), and the like. The encoded data streams are decoded by a video decoder that is compatible with the syntax of the encoded data stream.

Network communications to and from network 1710 may be communicated using the power grid 1704. Another communications modem 1714 connects to the home electrical network 1712. The communications modem 1714 may provide bidirectional communication for systems such as a media recorder 1716, a personal computer 1718, a home manager 1720 or any other suitable device or system.

A variety of digital video compression techniques have arisen to transmit or to store a video signal with a lower data rate or with less storage space. Such video compression techniques include international standards, such as H.261, H.263, H.263+, H.263++, H.264, MPEG-1, MPEG-2, MPEG-4, and MPEG-7. These compression techniques achieve relatively high compression ratios by discrete cosine transform (DCT) techniques and motion compensation (MC) techniques, among others.

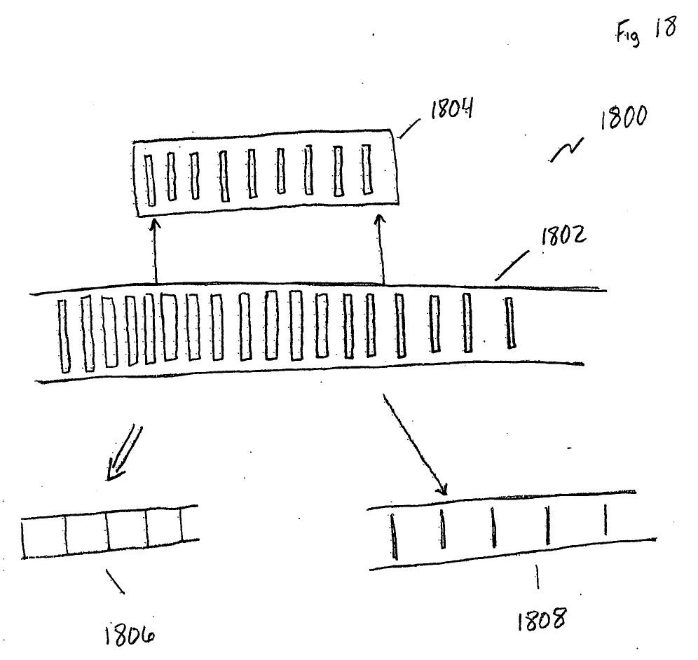

With reference to FIG. 18, representational diagrams of content signal streams 1800 are shown. A content signal stream 1802 may include one or more highlight segments 1804, where the highlight segments 1804 typically represent high-interest portions of the content signal stream 1802. The highlight segments 1804 may be collected from a single content signal stream 1802 to form a summary segment 1806. Highlight segments 1804 may be collected from a collection of content signal streams 1802 to form a best-of-collection segment 1808.

In some cases, the methods further include mixing two or more content objects from the first plurality of content object entities to form a composite content object, and providing the composite content object to a content object entity capable of utilizing it. In other cases, the methods further include eliminating a portion of a content object accessed from one group of content object entities and providing this reduced content object to another content object entity capable of utilizing the reduced content object entity.

It will be appreciated by those skilled in the art having the benefit of this disclosure that this invention provides a system of providing layered media content. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A process for displaying a user-selected presentation of video segments from video content comprising the steps of:
receiving content;
recording content;
receiving segment data;
recording segment data;
receiving selection instructions wherein said instructions are associated with segment data;
retrieving video segments associated with said selection instructions from said content with said segment data;
displaying said video segments.
